(19) United States
(12) Patent Application Publication
(10) Pub. No.: US 2025/0251631 A1
(43) Pub. Date: Aug. 7, 2025

(54) LIQUID CRYSTAL PANEL

(71) Applicant: Japan Display Inc., Tokyo (JP)

(72) Inventors: Shunichi KIMURA, Tokyo (JP); Toshiharu MATSUSHIMA, Tokyo (JP); Yuji MAEDE, Tokyo (JP)

(73) Assignee: Japan Display Inc., Tokyo (JP)

(21) Appl. No.: 19/038,734

(22) Filed: Jan. 28, 2025

(30) Foreign Application Priority Data
Feb. 1, 2024 (JP) 2024-014393

(51) Int. Cl. G02F 1/1343; G02F 1/1333; G02F 1/1345

(52) U.S. Cl. CPC G02F 1/134309; G02F 1/133354; G02F 1/133368; G02F 1/1345

(57) ABSTRACT

A liquid crystal panel includes two substrates and a liquid crystal. One of the two substrates includes a resistance layer having a circular outer periphery, an electrode layer having an electric resistance lower than that of the resistance layer, a first transmission part provided with a first potential, a second transmission part provided with a second potential, and an intermediate transmission part provided with a potential between the first and second potentials. The electrode layer includes: a first electrode at a center; a second electrode having an annular shape along the outer periphery of the resistance layer; and an intermediate electrode having an annular shape between the first and second electrodes and concentric with the second electrode. The first transmission part and the first electrode are coupled. The second transmission part and the second electrode are coupled. The intermediate transmission part and the intermediate electrode are coupled.

### CROSS-REFERENCE TO RELATED APPLICATION

This application claims the benefit of priority from Japanese Patent Application No. 2024-014393 filed on Feb. 1, 2024, the entire contents of which are incorporated herein by reference.

### BACKGROUND

### 1. Technical Field

What is disclosed herein relates to a liquid crystal panel.

### 2. Description of the Related Art

As disclosed in Japanese Patent Application Laid-open Publication No. 2022-167026, a liquid crystal panel has been known which is capable of controlling alignment of liquid crystal molecules to produce an optical effect similar to that of a lens.

Causing a liquid crystal panel to function as a lens needs adjusting the refractive index of light in a light-transmitting region of the liquid crystal panel such that the refractive index corresponds to the curvature of the lens. Such a refractive index of light has conventionally been achieved by performing voltage control to apply different voltages to the liquid crystal at the center of the light-transmitting region and the liquid crystal at the outer periphery of the light-transmitting region. However, only with the potential difference between two positions at the center and the outer periphery of the light-transmitting region, it has been difficult to achieve liquid crystal alignment control that allows for more highly accurately reproducing the refractive index of light corresponding to the curvature of a lens.

For the foregoing reasons, there is a need for a liquid crystal panel that facilitates achieving liquid crystal alignment control that allows for more highly accurately reproducing the refractive index of light corresponding to the curvature of a lens.

### SUMMARY

According to an aspect, a liquid crystal panel includes two substrates and a liquid crystal sandwiched between the two substrates. A first substrate that is one of the two substrates includes a resistance layer provided in a light-transmitting region and having a circular outer periphery, an electrode layer stacked with the resistance layer and having an electric resistance lower than that of the resistance layer, a first transmission part configured to be provided with one of two potentials different from each other, a second transmission part configured to be provided with the other of the two potentials different from each other, and an intermediate transmission part configured to be provided with an intermediate potential between the two potentials different from each other. The electrode layer includes: a first electrode disposed at a center of the resistance layer; a second electrode that has an annular shape and extends along the outer periphery of the resistance layer; and an intermediate electrode that has an annular shape, is disposed between the first and second electrodes, and is concentric with the second electrode. The first transmission part and the first electrode are coupled to each other. The second transmission part and the second electrode are coupled to each other. The intermediate transmission part and the intermediate electrode are coupled to each other.

### BRIEF DESCRIPTION OF THE DRAWINGS

FIG. 1 is a schematic view illustrating an optical device of an embodiment;

FIG. 2 is a plan view illustrating a schematic structure in a light-transmitting region;

FIG. 3 is a virtual sectional view with one end near the center of the light-transmitting region and the other end at the outer peripheral end of the light-transmitting region;

FIG. 4 is a plan view illustrating an example of the shapes and positional relation of a high-resistance film layer, an electrode layer, and a transmission part layer and an example of a coupling point of the electrode layer and the transmission part layer;

FIG. 5 is a V-V sectional view of FIG. 4;

FIG. 6 is a VI-VI sectional view of FIG. 4;

FIG. 7 is a VII-VII sectional view of FIG. 4;

FIG. 8 is a graph illustrating the relation between the distance from the center of the light-transmitting region and a phase change amount;

FIG. 9 is a graph illustrating an example of finer potential control in a range FP in FIG. 8;

FIG. 10 is a plan view illustrating a schematic structure in a light-transmitting region AA of an optical device according to a first modification; and

FIG. 11 is a plan view illustrating a schematic structure in the light-transmitting region AA of the optical device according to the first modification.

### DETAILED DESCRIPTION

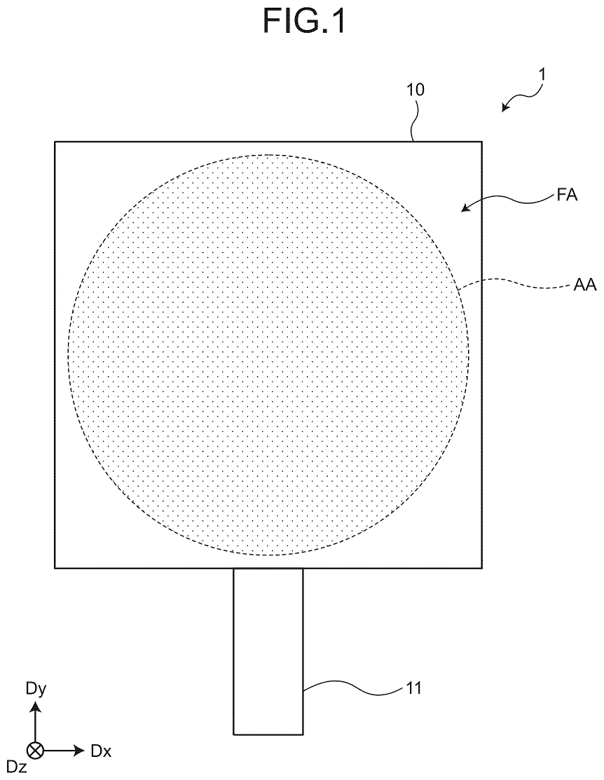

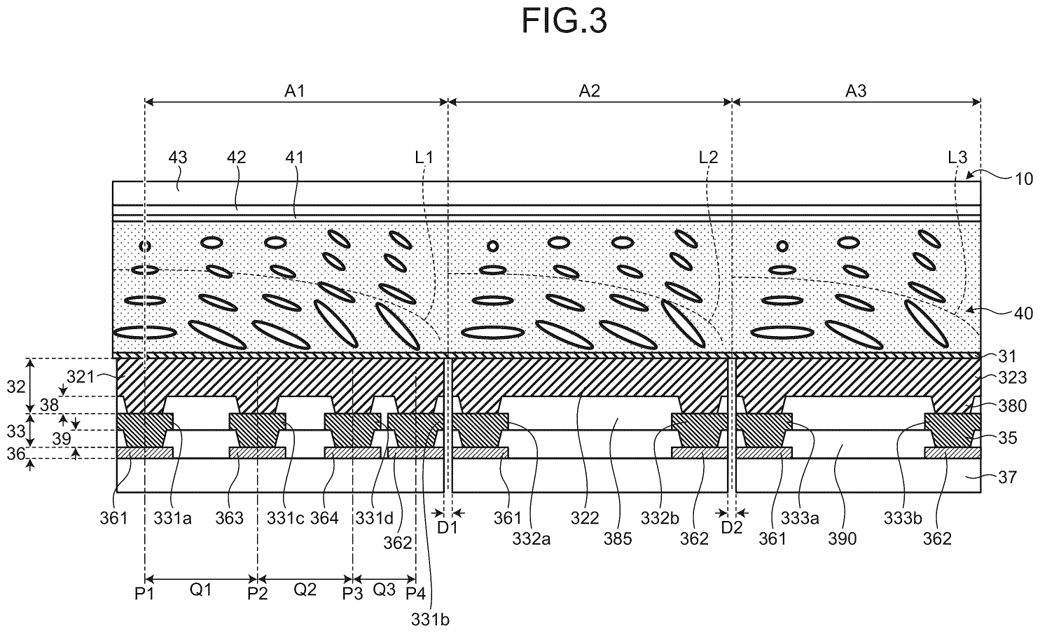

An embodiment of the present disclosure is described below with reference to the drawings. What is disclosed herein is only an example, and any modifications that can be easily conceived by those skilled in the art while maintaining the main purpose of the invention are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate. FIG. 1 is a schematic view illustrating an optical device 1 of an embodiment. The optical device 1 includes a liquid crystal panel 10 and a flexible substrate 11. The liquid crystal panel 10 is a liquid crystal panel in which a liquid crystal 40 (refer to FIG. 3) is sealed. The flexible substrate 11 includes a plurality of wiring lines coupling the liquid crystal panel 10 to an external control device.

In description of the embodiment, a first direction Dx refers to a direction along the surface of the liquid crystal panel 10. A second direction Dy refers to a direction along the surface of the liquid crystal panel 10 and orthogonal to the first direction Dx. A third direction Dz refers to a direction orthogonal to the first direction Dx and the second direction Dy.

As illustrated in FIG. 1, the liquid crystal panel 10 includes a light-transmitting region AA and a peripheral region FA. The light-transmitting region AA is a region having a circular edge in a plan view, for example. The peripheral region FA is a region surrounding the edge of the light-transmitting region AA in a plan view. A plan view is a view in which the surface of the liquid crystal panel 10 is viewed from a viewpoint in front of the surface. The light-transmitting region AA is controlled such that the light-transmitting region AA transmits light traveling from one surface side of the liquid crystal panel 10 toward the other surface side when the optical device 1 is in operation. The peripheral region FA is provided such that the peripheral region FA does not transmit light.

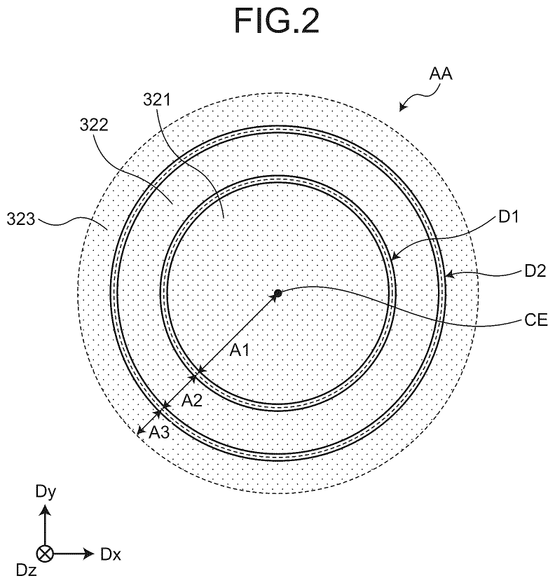

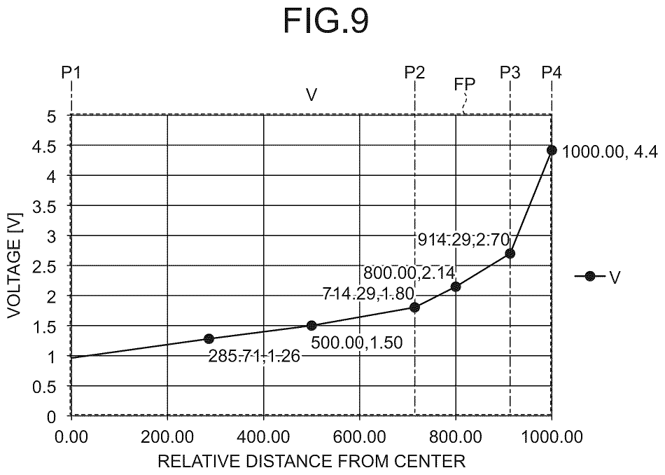

FIG. 2 is a plan view illustrating a schematic structure in the light-transmitting region AA. The light-transmitting region AA includes a plurality of concentric circular regions with reference to a center CE of the circle of the light-transmitting region AA. FIG. 2 illustrates an example in which three concentric circular regions of a first region A1, a second region A2, and a third region A3 are provided, but this is merely exemplary. The number of concentric circular regions may be two or may be equal to or greater than four (refer to FIGS. 8 and 9). The concentric circular regions include the first region A1 and one or more annular regions (for example, the second region A2 and the third region A3). The first region A1 is a circular region positioned at the center CE. The one or more annular regions are provided outside the circular region (first region A1) in the radial direction of the translucent region AA and surround the circular region. Hereinafter, the radial direction means the radial direction of the circle of the light-transmitting region AA unless otherwise noted. In addition, a concentric circular region means any of the circular region and the annular regions.

FIG. 3 is a virtual sectional view with one end near the center CE of the light-transmitting region AA and the other end at the outer peripheral end of the light-transmitting region AA. This virtual sectional view is intended to indicate a relative arrangement order of components between one end and the other end among their arrangement orders for achieving electric characteristics of the liquid crystal panel 10. In other words, no section identical to FIG. 3 is obtained at any position of the liquid crystal panel 10 in an actual physical sectional view of the liquid crystal panel 10 in the radial direction with one end defined at the center CE of the liquid crystal panel 10 and the other end defined at the outer peripheral end of the liquid crystal panel 10. FIG. 3 merely indicates the relation of arrangement of electric components of the liquid crystal panel 10 with the radial direction of the liquid crystal panel 10.

The liquid crystal panel 10 includes a first substrate 37 and a second substrate 43 facing each other in the third direction Dz with the liquid crystal 40 interposed therebetween. The first substrate 37 and the second substrate 43 are light-transmitting substrates such as glass substrates.

On the liquid crystal 40 side of the second substrate 43, an alignment film 41 and a common electrode 42 are stacked in the stated order from the liquid crystal 40 side toward the second substrate 43 side. The alignment film 41 is an insulating layer having grooves formed on the surface on the liquid crystal 40 side. The grooves define initial alignment of liquid crystal molecules contained in the liquid crystal 40. The common electrode 42 is an electrode covering the entire light-transmitting region AA.

On the liquid crystal 40 side of the first substrate 37, an alignment film 31, a high-resistance film layer 32, an electrode layer 33, and a transmission part layer 36 are stacked in the stated order from the liquid crystal 40 toward the first substrate 37 side. The alignment film 31 is an insulating layer having grooves formed on the surface on the liquid crystal 40 side. The grooves define initial alignment of the liquid crystal molecules contained in the liquid crystal 40. The high-resistance film layer 32 has a relatively high electric resistance as compared to the common electrode 42 and the electrode layer 33 but is a film layer (high-resistance film) that functions as an electric conductor. Specifically, the high-resistance film layer 32 is formed of indium tin oxide (ITO) or SiO₂. A specific example of the electric resistance value of the high-resistance film layer 32 is determined in the range of 10⁶ ohm-meter (Ω/m²) to 10⁸ Ω/m² inclusive.

The high-resistance film layer 32 is individually provided in each of the above-described concentric circular regions. For example, as illustrated in FIGS. 2 and 3 and FIG. 4 to be described later, the high-resistance film layer 32 includes a first high-resistance film 321 provided in the first region A1, a second high-resistance film 322 provided in the second region A2, and a third high-resistance film 323 provided in the third region A3. The circles of the outer periphery edges of the first region A1, the second region A2, and the third region A3 have the same center at the center CE. In other words, the first region A1, the second region A2, and the third region A3 are a plurality of concentric circular regions having the circular outer peripheries with the common center. As illustrated in FIG. 2, the first high-resistance film 321 has a circular shape in a plan view. The second high-resistance film 322 has an annular shape surrounding the first high-resistance film 321. The third high-resistance film 323 has an annular shape surrounding the second high-resistance film 322.

A spacing is provided between concentric circular regions adjacent to each other in the radial direction among the concentric circular regions. FIGS. 2 and 3 and FIG. 4 to be described later exemplarily illustrate a spacing D1 between the first region A1 and the second region A2 and a spacing D2 between the second region A2 and the third region A3. The number of such spacings is a value obtained by subtracting one from the number of the concentric circular regions. The spacings are provided in the high-resistance film layer 32 and the electrode layer 33.

In the embodiment, among the concentric circular regions, the outer concentric circular region has a smaller width in the radial direction. According to the widths of these concentric circular regions, among the high-resistance films of the high-resistance film layer 32, the high-resistance film located in the outer concentric circular region has a smaller width in the radial direction.

The electrode layer 33 is a film layer that functions as an electric conductor. Specifically, the electrode layer 33 and the common electrode 42 are formed from thin light-transmitting conductive films of, for example, indium tin oxide (ITO) or indium zinc oxide (IZO) but may be formed of an extremely highly conductive non-light-transmitting material such as copper or aluminum.

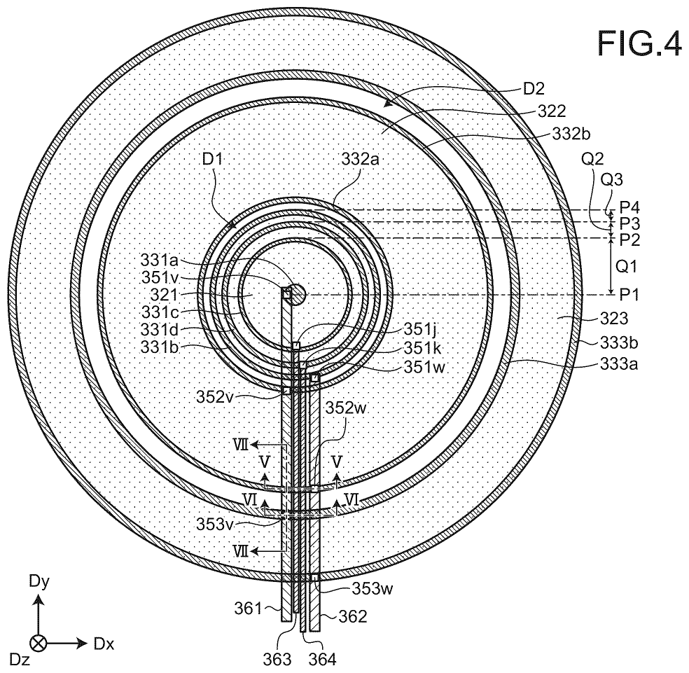

FIG. 4 is a plan view illustrating an example of the shapes and positional relation of the high-resistance film layer 32, the electrode layer 33, and the transmission part layer 36 and an example of a coupling point of the electrode layer 33 and the transmission part layer 36. The electrode layer 33 includes a first electrode 331a, a second electrode 331b, a first electrode 332a, a second electrode 332b, a first electrode 333a, and a second electrode 333b. The first electrode 331a is provided overlapping the center CE (refer to FIG. 2) of the first high-resistance film 321. The shape of the first electrode 331a in a plan view is, for example, a circular shape but may be a point or polygonal shape.

The second electrode 331b is provided in an area overlapping the first high-resistance film 321 along the outer periphery of the first high-resistance film 321. The first electrode 332a is provided in an area overlapping the second high-resistance film 322 along the inner periphery of the second high-resistance film 322. The second electrode 332b is provided in an area overlapping the second high-resistance film 322 along the outer periphery of the second high-resistance film 322. The first electrode 333a is provided in an area overlapping the third high-resistance film 323 along the inner periphery of the third high-resistance film 323. The second electrode 333b is provided in an area overlapping the third high-resistance film 323 along the outer periphery of the third high-resistance film 323. The shapes of the second electrode 331b, the first electrode 332a, the second electrode 332b, the first electrode 333a, and the second electrode 333b in a plan view are full circular rings.

As illustrated in FIGS. 3 and 4, the first electrode 331a and the second electrode 331b are separated from each other in the radial direction. The first electrode 332a and the second electrode 332b are separated from each other in the radial direction. The first electrode 333a and the second electrode 333b are separated from each other in the radial direction.

The electrode layer 33 further includes a third electrode 331c and a fourth electrode 331d. As illustrated in FIG. 4, the shapes of the third electrode 331c and the fourth electrode 331d in a plan view are full circular rings. The third electrode 331c and the fourth electrode 331d are concentric with the second electrode 331b. The fourth electrode 331d has a diameter smaller than that of the second electrode 331b. The third electrode 331c has a diameter smaller than those of the second electrode 331b and the fourth electrode 331d.

As illustrated in FIGS. 3 and 4, the first electrode 331a and the third electrode 331c are separated from each other in the radial direction. The third electrode 331c and the fourth electrode 331d are separated from each other in the radial direction. The fourth electrode 331d and the second electrode 331b are separated from each other in the radial direction.

The middle position of the width of the first electrode 331a in the radial direction is referred to as a position P1. In the embodiment, the position P1 coincides with the center CE of the light-transmitting region AA in the radial direction. The middle position of the width of the third electrode 331c in the radial direction is referred to as a position P2. The middle position of the width of the fourth electrode 331d in the radial direction is referred to as a position P3. The middle position of the width of the second electrode 331b in the radial direction is referred to as a position P4. The spacing between the positions P1 and P2 in the radial direction is referred to as a spacing Q1. The spacing between the positions P2 and P3 in the radial direction is referred to as a spacing Q2. The spacing between the positions P3 and P4 in the radial direction is referred to as a spacing Q3. The spacing Q1 is larger than the spacings Q2 and Q3. The spacing Q2 is larger than the spacing Q3.

The high-resistance film layer 32 and the electrode layer 33 are coupled to each other through contacts formed at the positions where the high-resistance film layer 32 and the electrode layer 33 overlap. FIG. 3 exemplarily illustrates contacts 380 coupling the third high-resistance film 323 and the second electrode 333b. The contacts 380 are formed in a coupling part layer 38. The coupling part layer 38 is a part of the high-resistance film layer 32 and is a part of the high-resistance film layer 32 on the electrode layer 33 side.

In the embodiment, among the contacts formed at the positions where the high-resistance film layer 32 and the electrode layer 33 overlap each other, only a contact coupling the first high-resistance film 321 and the first electrode 331a has a point-like shape whereas the other contacts have full circular ring shapes.

The transmission part layer 36 is a conductive layer overlapping a part of the electrode layer 33 in a plan view. The transmission part layer 36 is formed of an extremely highly conductive material such as copper or aluminum.

The transmission part layer 36 includes a first potential line 361 and a second potential line 362. The first potential line 361 overlaps parts of components provided on the inner periphery side of the concentric circular regions of the electrode layer 33. Specifically, as illustrated in FIGS. 3 and 4, the first potential line 361 overlaps the first electrodes 331a, 332a, and 333a. The second potential line 362 overlaps parts of components provided on the outer periphery side of the concentric circular regions in the electrode layer 33. Specifically, as illustrated in FIGS. 3 and 4, the second potential line 362 overlaps the second electrodes 331b, 332b, and 333b.

The transmission part layer 36 further includes a third potential line 363 and a fourth potential line 364. The third potential line 363 overlaps the third electrode 331c in the electrode layer 33. The fourth potential line 364 overlaps the fourth electrode 331d in the electrode layer 33.

The first potential line 361, the second potential line 362, the third potential line 363, and the fourth potential line 364 illustrated in FIG. 4 each extend in the second direction Dy. The position of one end of the first potential line 361 is a position overlapping the first electrode 331a. The position of one end of the second potential line 362 is a position overlapping the second electrode 331b. The position of one end of the third potential line 363 is a position overlapping the third electrode 331c. The position of one end of the fourth potential line 364 is a position overlapping the fourth electrode 331d.

The other ends of the first potential line 361, the second potential line 362, the third potential line 363, and the fourth potential line 364 extend further outward than the second electrode 333b in the radial direction. Although not illustrated, the first potential line 361, the second potential line 362, the third potential line 363, and the fourth potential line 364 are coupled to power supply points with different potentials, respectively, on the other end side.

The first potential line 361, the second potential line 362, the third potential line 363, and the fourth potential line 364 illustrated in FIG. 4 are arranged from one side toward the other side in the first direction Dx in the order of the first potential line 361, the third potential line 363, the fourth potential line 364, and the second potential line 362. This arrangement order is merely exemplary and not limited, and may be changed as appropriate.

The electrode layer 33 and the transmission part layer 36 are coupled to each other through contacts formed at the positions where the electrode layer 33 and the transmission part layer 36 overlap each other. FIG. 3 exemplarily illustrates contacts 35 coupling the second electrode 333b and the second potential line 362. The contacts 35 are formed in a coupling part layer 39. The coupling part layer 39 is a part of the electrode layer 33 and is a part of the electrode layer 33 on the transmission part layer 36 side.

A component included in the electrode layer 33 and a component included in the transmission part layer 36 other than combination of the second electrode 333b and the second potential line 362 are coupled to each other through contacts as well. Specifically, the first potential line 361 is coupled to the first electrodes 331a, 332a, and 333a. The second potential line 362 is coupled to the second electrodes 331b, 332b, and 333b. The third potential line 363 is coupled to the third electrode 331c. The fourth potential line 364 is coupled to the fourth electrode 331d.

Specifically, a contact 351v illustrated in FIG. 4 couples the first potential line 361 and the first electrode 331a. The first potential line 361 and the first electrode 331a overlap each other in a plan view at the position where the contact 351v is provided. The structure of the contact 351v in a sectional view has the same configuration as that of the contacts 35 described above with reference to FIG. 3. Specifically, part of the electrode layer 33 and part of the transmission part layer 36, which are coupled by a contact such as the contact 351v, overlap each other in a plan view at a position where the contact is formed.

A contact 352v couples the first potential line 361 and the first electrode 332a. A contact 353v couples the first potential line 361 and the first electrode 333a. A contact 351w couples the second potential line 362 and the second electrode 331b. A contact 352w couples the second potential line 362 and the second electrode 332b. A contact 353w couples the second potential line 362 and the second electrode 333b. A contact 351j couples the third potential line 363 and the third electrode 331c. A contact 351k couples the fourth potential line 364 and the fourth electrode 331d. The contacts 352v, 353v, 351w, 352w, 353w, 351j, and 351k have the same structure as that of the contacts 35 described above with reference to FIG. 3 in a sectional view, and these contacts are provided integrally with the electrode layer 33 as illustrated in FIG. 3 with the contacts 35 as an example.

In a case where the electrode layer 33 and the transmission part layer 36 overlap each other in a plan view but no contact is provided at the position of the overlapping, coupling is not made at the position of the overlapping.

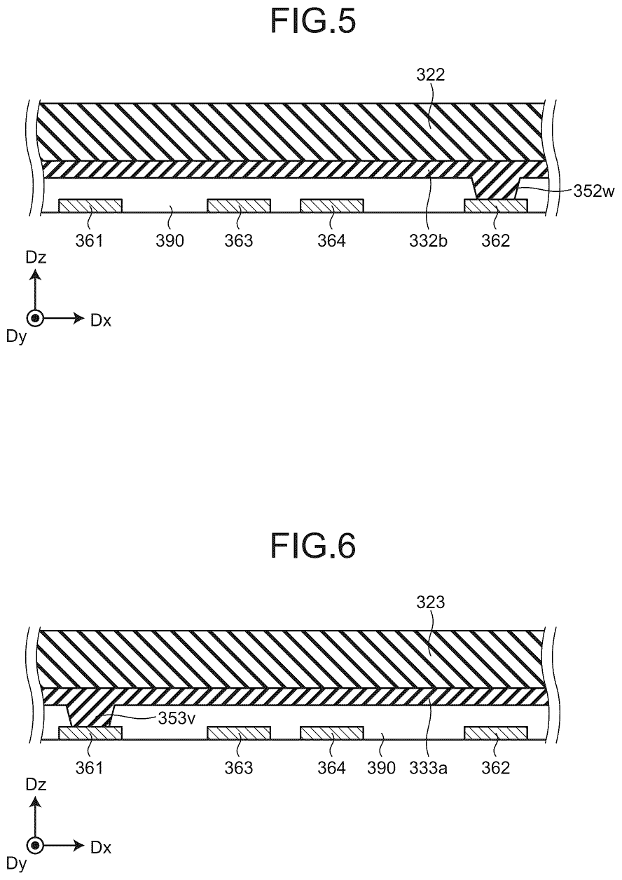

FIG. 5 is a V-V sectional view of FIG. 4. As described above, the first potential line 361, the third potential line 363, the fourth potential line 364, and the second potential line 362 illustrated in FIG. 4 are arranged in the first direction Dx. As illustrated in FIGS. 4 and 5, the first potential line 361, the third potential line 363, the fourth potential line 364, and the second potential line 362 are arranged in the first direction Dx even in a region along the second direction Dy where the contact 352w is provided. Among the first potential line 361, the third potential line 363, the fourth potential line 364, and the second potential line 362, only the second potential line 362 is coupled to the second electrode 332b through the contact 352w. In other words, the first potential line 361, the third potential line 363, and the fourth potential line 364 are not coupled to the second electrode 332b. Accordingly, the potential of the second electrode 332b is a potential corresponding to the second potential line 362.

FIG. 6 is a VI-VI sectional view of FIG. 4. As illustrated in FIGS. 4 and 6, the first potential line 361, the third potential line 363, the fourth potential line 364, and the second potential line 362 are arranged in the first direction Dx even in a region along the second direction Dy where the contact 353v is provided. Among the first potential line 361, the third potential line 363, the fourth potential line 364, and the second potential line 362, only the first potential line 361 is coupled to the first electrode 333a through the contact 353v. In other words, the second potential line 362, the third potential line 363, and the fourth potential line 364 are not coupled to the first electrode 333a. Accordingly, the potential of the first electrode 333a is a potential corresponding to the first potential line 361.

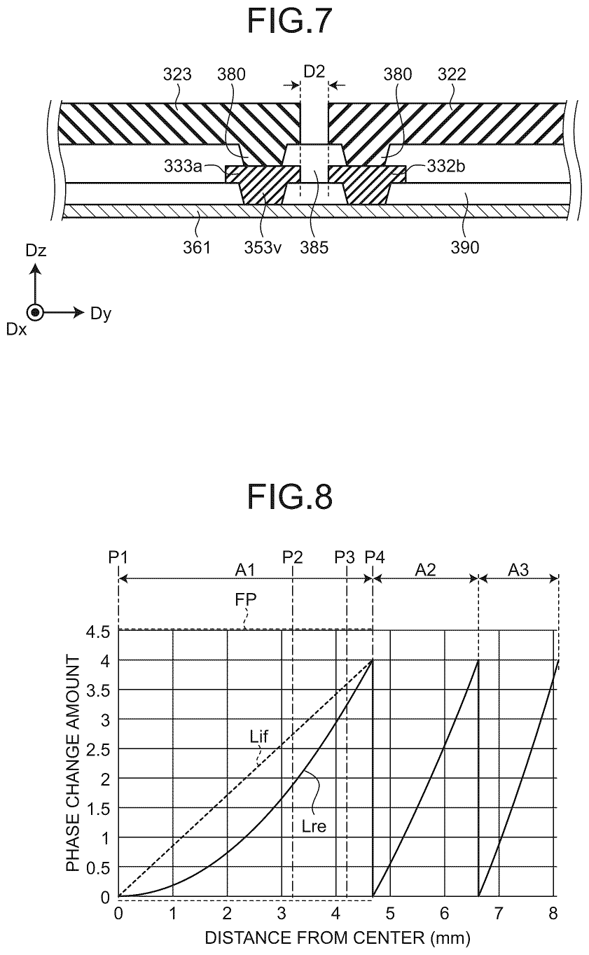

FIG. 7 is a VII-VII sectional view of FIG. 4. As illustrated in FIGS. 4 and 7, a plurality of components included in the electrode layer 33, such as the first electrode 333a and the second electrode 332b, are provided in a region where the first potential line 361 extends in the second direction Dy. However, as described above, the first potential line 361 is coupled to the first electrodes 331a, 332a, and 333a. Accordingly, as illustrated in FIG. 7, the first potential line 361 is coupled to the first electrode 333a through the contact 353v but not coupled to the second electrode 332b.

As illustrated in FIG. 3, an insulating layer 390 is provided in a region of the transmission part layer 36 where none of the first potential line 361, the second potential line 362, the third potential line 363, and the fourth potential line 364 are provided and in a region of the coupling part layer 39 where no contacts such as the contacts 35 are provided. In addition, an insulating layer 385 is provided in a region of the electrode layer 33 where none of the first electrode 331a, the second electrode 331b, the first electrode 332a, the second electrode 332b, the first electrode 333a, the second electrode 333b, the third electrode 331c, and the fourth electrode 331d are provided and in a region of the coupling part layer 38 where no contacts such as the contacts 380 are provided. The insulating layers 385 and 390 are formed of, for example, a silicon oxide (SiO) based light-transmitting material or a silicon nitride (SiN) based light-transmitting material.

The stacking structure and the coupling relation described above with reference to FIGS. 3 to 7 generate a potential difference between the inner side and the outer side of the electrode layer 33 and the high-resistance film layer 32 in the radial direction. Specifically, the potential difference between a potential provided to the first potential line 361 and a potential provided to the second potential line 362 generates a potential gradient between the inner side and the outer side of the electrode layer 33 and the high-resistance film layer 32 in the radial direction. Accordingly, the liquid crystal molecules contained in the liquid crystal 40 are aligned in accordance with the potential gradient in each of the first region A1, the second region A2, and the third region A3 as illustrated in FIG. 3. More specifically, the alignment of the liquid crystal molecules is set by the relation between the potential gradient and a constant potential provided to the common electrode 42.

Assume that: the potential difference between the potential provided to the first potential line 361 and the potential provided to the second potential line 362 is referred to as a first potential difference; the potential provided to the third potential line 363 is referred to as a third potential; and the potential provided to the fourth potential line 364 is referred to as a fourth potential, wherein the third potential line 363 and the fourth potential line 364 are disposed between the first potential line 361 and the second potential line 362. In the first region A1, not only the first potential difference but also the third and fourth potentials affect the potential gradient between the inner side and the outer side of the electrode layer 33 and the high-resistance film layer 32 in the radial direction and the alignment of the liquid crystal molecules in accordance with the potential gradient.

FIG. 8 is a graph illustrating the relation between the distance from the center CE of the light-transmitting region AA and a phase change amount. The phase change amount corresponds to a potential provided to the high-resistance film layer 32 through the transmission part layer 36 and the electrode layer 33.

As described above, the first potential line 361, the second potential line 362, the third potential line 363, and the fourth potential line 364 are respectively coupled to power supply points with different potentials on the other end side. That is, different potentials are respectively provided to the first potential line 361, the second potential line 362, the third potential line 363, and the fourth potential line 364. In other words, the first electrodes 331a, 332a, and 333a coupled to the first potential line 361 have the same potential as the first potential line 361 in effect. In addition, the second electrodes 331b, 332b, and 333b coupled to the second potential line 362 have the same potential as that of the second potential line 362 in effect.

Thus, a potential corresponding to the first potential line 361 is provided to the liquid crystal 40 at the inner peripheral end of each of the first region A1, the second region A2, and the third region A3 in the radial direction. In addition, a potential corresponding to the second potential line 362 is provided to the liquid crystal 40 at the outer peripheral end of each of the first region A1, the second region A2, and the third region A3 in the radial direction.

In the embodiment, the potential provided to the first potential line 361 is relatively the lowest among potentials provided to the first potential line 361, the second potential line 362, the third potential line 363, and the fourth potential line 364. In the embodiment, the potential provided to the second potential line 362 is relatively the highest among potentials provided to the first potential line 361, the second potential line 362, the third potential line 363, and the fourth potential line 364. More specifically, the potential provided to the first potential line 361 is, for example, 0 volt (V). Accordingly, as illustrated in FIG. 8, the potential at the inner peripheral end of each of the first region A1, the second region A2, and the third region A3 in the radial direction is 0 volt (V). The potential provided to the second potential line 362 is, for example, 4.4 volt (V) (refer to FIG. 9). Accordingly, as illustrated in FIG. 8, the potential at the outer peripheral end of each of the first region A1, the second region A2, and the third region A3 in the radial direction is 4 volt (V). Such a potential difference is caused by electric resistance of the high-resistance film layer 32. In the second region A2 and the third region A3, the potential gradient from the inner peripheral end to the outer peripheral end in the radial direction exhibits a tendency to linearly increase from 0 volt (V) to 4 volt (V) as illustrated in FIG. 8.

FIG. 9 is a graph illustrating an example of finer potential control in a range FP in FIG. 8. The third potential line 363 and the fourth potential line 364 are provided in the first region A1. The third electrode 331c coupled to the third potential line 363 has the same potential as the third potential line 363 in effect. The fourth electrode 331d coupled to the fourth potential line 364 has the same potential as the fourth potential line 364 in effect.

In the embodiment, the potential provided to the third potential line 363 is higher than that of the first potential line 361 and lower than that of the fourth potential line 364. In the embodiment, the potential provided to the fourth potential line 364 is higher than that of the third potential line 363 and lower than that of the second potential line 362. More specifically, the potential provided to the third potential line 363 is, for example, 1.8 volt (V). The potential provided to the fourth potential line 364 is, for example, 2.7 volt (V).

Thus, as illustrated in FIG. 9, in the first region A1, 0 volt (V) is provided to the position P1 from the first potential line 361, 1.8 volt (V) is provided to the position P2 from the third potential line 363, 2.7 volt (V) is provided to the position P3 from the fourth potential line 364, and 4.4 volt (V) is provided to the position P4 from the second potential line 362. Accordingly, as illustrated in FIG. 8, the potential gradient in the first region A1 exhibits a tendency that potential increases from the inner peripheral end to the outer peripheral end in the radial direction, and the potential gradient therein is such a non-linear potential gradient Lre that the increase in potential is less steep in a region closer to the inner periphery side and the increase in potential is steep in a region closer to the outer periphery side.

As described above, the spacing Q1 is the spacing between the positions P1 and P2 in the radial direction. The spacing Q2 is the spacing between the positions P2 and P3 in the radial direction. The spacing Q3 is the spacing between the positions P3 and P4 in the radial direction. FIG. 9 exemplarily indicates, with numerical values, the relative position of the position P2 and the relative position of the position P3 when the position P1 is defined as the position “0.00” and the position P4 is defined as the position “1000.00”. Specifically, in the notation “714.29, 1.80” provided near a black point on a dashed and single-dotted line representing the position P2, the number “714.29” indicates the position of the position P2. In the notation “914.29, 2.70” provided near a black point on a dashed and single-dotted line representing the position P3, the number “914.29” indicates the position of the position P3. Thus, when the distance between the positions P1 and P4 is defined as 100 percent (%), the spacing Q1, which is the distance between the positions P1 and P2, is 71.429 percent (%), the spacing Q2, which is the distance between the positions P2 and P3, is 20 percent (%), and the spacing Q3, which is the distance between the positions P3 and P4, is 8.571 percent (%).

The positions and potentials of the positions P2 and P3 described above with reference to FIG. 9 are set to approximate the potential gradient in the first region A1 to an ideal potential gradient. For example, in the embodiment, it is desirable that the potential at the position “285.71” is 1.26 volt (V), the potential at the position “500.00” is 1.5 volt (V), and the potential at the position “800.00” is 2.14 volt (V) as illustrated in FIG. 9. In the embodiment, by assuming the relation of these positions and potentials, the positions and potentials of the positions P2 and P3 are determined. The ratios of the spacings Q1, Q2, and Q3 to the diameter of the first region A1 illustrated in FIG. 9 are merely exemplary and not limited, and may be changed as appropriate in accordance with specifically requested designing matters.

As illustrated in FIGS. 3 and 4, the first electrode 331a, the second electrode 331b, the third electrode 331c, and the fourth electrode 331d are stacked on the first high-resistance film 321. The first electrode 331a is electrically coupled to the first potential line 361. The second electrode 331b is electrically coupled to the second potential line 362. The third electrode 331c is electrically coupled to the third potential line 363. The fourth electrode 331d is electrically coupled to the fourth potential line 364. Since the potential of the first potential line 361 and the potential of the second potential line 362 are different from each other, the first potential line 361 functions as a first transmission part to which one of two potentials different from each other is provided. The second potential line 362 functions as a second transmission part to which the other of the two potentials different from each other is provided. With the above-described potential relation between the first, second, third, and fourth potential lines 361, 362, 363, and 364, the third potential line 363 and the fourth potential line 364 each function as an intermediate transmission part to which an intermediate potential between the two potentials different from each other is provided. The first electrode 331a included in the electrode layer 33 is a component disposed at the center CE of the first high-resistance film 321. The second electrode 331b included in the electrode layer 33 is a component that is annular and extends along the outer periphery of the first high-resistance film 321. The third electrode 331c and the fourth electrode 331d included in the electrode layer 33 are each an annular component that is disposed between the first electrode 331a and the second electrode 331b and is concentric with the second electrode 331b. Thus, the third electrode 331c and the fourth electrode 331d each function as an intermediate electrode. Accordingly, the first high-resistance film 321 on which the first electrode 331a, the second electrode 331b, the third electrode 331c, and the fourth electrode 331d are stacked, corresponds to a resistance layer.

In the embodiment, two potential lines: the third potential line 363 and the fourth potential line 364 are provided as components that function as the intermediate transmission parts, and two electrodes: the third electrode 331c and the fourth electrode 331d are provided as components that function as the intermediate electrodes. As illustrated in FIG. 4, one (third electrode 331c) of the intermediate electrodes has a smaller ring diameter than the other (fourth electrode 331d). Potentials provided to the two intermediate transmission parts are different from each other, and the relation in potential magnitude between potentials provided to the first electrode 331a and the second electrode 331b is the same as the relation in potential magnitude between potentials provided to the third electrode 331c and the fourth electrode 331d. The third electrode 331c is one of the two intermediate electrodes, and the fourth electrode 331d is the other. Specifically, in the embodiment, the potential provided to the first electrode 331a is lower than the potential provided to the second electrode 331b. The potential provided to the third electrode 331c is lower than the potential provided to the fourth electrode 331d.

In the embodiment, the second high-resistance film 322 and the third high-resistance film 323 are included in the high-resistance film layer 32 as components provided in the same layer as the first high-resistance film 321 corresponding to the above-described resistance layer. The second high-resistance film 322 and the third high-resistance film 323 are annular components that are concentric with the first high-resistance film 321 and surround the first high-resistance film 321. Thus, the second high-resistance film 322 and the third high-resistance film 323 correspond to an annular resistance layer. The first electrodes 332a and 333a coupled to the first potential line 361 each function as a first annular electrode that is annular and extends along the inner periphery of the annular resistance layer. Second electrodes 322b and 323b coupled to the second potential line 362 each function as a second annular electrode that is annular and extends along the outer periphery of the annular resistance layer.

Alignment of the liquid crystal molecules contained in the liquid crystal 40 is controlled in accordance with the potential gradient in each of the first region A1, the second region A2, and the third region A3 described above with reference to FIGS. 8 and 9, whereby the liquid crystal panel 10 exhibits an optical function similar to that of a Fresnel lens.

Specifically, as illustrated in FIG. 3, the longitudinal direction of the liquid crystal molecules contained in the liquid crystal 40 are substantially aligned with the surfaces of the first substrate 37 and the second substrate 43 on the inner periphery side in the radial direction of each of the first region A1, the second region A2, and the third region A3. The alignment of the liquid crystal molecules is controlled so that the tilt angle of the longitudinal direction of the liquid crystal molecules relative to the surfaces of the first substrate 37 and the second substrate 43 increases as the distance from the outer periphery side in the radial direction of each of the first region A1, the second region A2, and the third region A3 decreases. With such alignment of the liquid crystal molecules, on the inner periphery side of each of the first region A1, the second region A2, and the third region A3 in the radial direction, light traveling from one surface side of the liquid crystal panel 10 in the second direction Dy toward the other surface side exhibits a tendency to travel straight. With such alignment of the liquid crystal molecules, on the outer periphery side of each of the first region A1, the second region A2, and the third region A3 in the radial direction, the traveling direction of light traveling from one surface side of the liquid crystal panel 10 in the second direction Dy toward the other surface side exhibits a tendency to be refracted toward the inner periphery side at the liquid crystal panel 10. Accordingly, when light from a point light source disposed overlapping the center CE passes through the liquid crystal panel 10 under a predetermined condition, almost all of the light becomes parallel light traveling straight in the normal direction of the surface of the liquid crystal panel 10. The center CE is the center of the diameter of the light-transmitting region AA of the liquid crystal panel 10 in a plan view. The predetermined condition is that an appropriate correspondence relation holds between the distance between the point light source and the liquid crystal panel 10 and the degree of light refraction due to alignment of the liquid crystal molecules.

In FIG. 3, dashed lines L1, L2, and L3 are illustrated to schematically indicate optical effects as a Fresnel lens. The dashed line L1 indicates an optical effect produced by controlling alignment of the liquid crystal molecules contained in the liquid crystal 40 in the first region A1. The dashed line L2 indicates an optical effect produced by controlling alignment of the liquid crystal molecules contained in the liquid crystal 40 in the second region A2. The dashed line L3 indicates an optical effect produced by controlling alignment of the liquid crystal molecules contained in the liquid crystal 40 in the third region A3. The optical effect indicated by the dashed line L1 is produced by controlling alignment of the liquid crystal molecules contained in the liquid crystal 40 overlapping the first region A1 in a plan view. The liquid crystal 40 is controlled, in accordance with the potential gradient Lre (refer to FIG. 8) generated in the resistance layer by combination of two different potentials and intermediate potentials, so that the refractive index of the light-transmitting region for light entering the light-transmitting region along the facing direction of the two substrates differs between a first electrode and a second electrode. The first high-resistance film 321 is an example of the resistance layer. The potential of the first potential line 361 and the potential of the second potential line 362 are an example of the two different potentials. The potential of the third potential line 363 and the potential of the fourth potential line 364 are an example of the intermediate potentials. The third direction Dz is an example of the facing direction. The first substrate 37 and the second substrate 43 are an example of the two substrates. The first electrode 331a is an example of the first electrode, and the second electrode 331b is an example of the second electrode.

The following discusses a reference example in which the third potential line 363, the fourth potential line 364, the third electrode 331c, and the fourth electrode 331d are omitted from the liquid crystal panel 10. In the first region A1 of the reference example, the potential gradient from the inner peripheral end to the outer peripheral end in the radial direction tends to linearly increase from 0 volt (V) to 4 volt (V), which is a phase gradient Lif illustrated in FIG. 8. In the reference example in which the phase gradient Lif is generated, it becomes difficult to achieve alignment of the liquid crystal molecules for more ideally approximating its function to the above-described function as a Fresnel lens in the first region A1 among the concentric circular regions, wherein the first region A1 has the width in the radial direction larger than those of the other concentric circular regions (for example, the second region A2 and the third region A3). Specifically, the tilt angle (degree of steepness) of the longitudinal direction of the liquid crystal molecules becomes excessively large in an intermediate region between the inner and outer peripheral ends of the first region A1 in the radial direction. However, since the configuration of the embodiment includes the third potential line 363, the fourth potential line 364, the third electrode 331c, and the fourth electrode 331d, alignment of the liquid crystal molecules for more ideally approximating its function to the above-described function as a Fresnel lens can be more easily achieved with the above-described potential gradient Lre. Thus, according to the embodiment, it is possible to form a potential gradient more highly accurately corresponding to the curvature of a desired lens and more highly accurately achieve an optical effect similar to that of the desired lens through alignment control of the liquid crystal molecules with the potential gradient.

In the embodiment, components that function as intermediate potential layers are two potential lines of the third potential line 363 and the fourth potential line 364, and components that function as intermediate electrodes are two electrodes of the third electrode 331c and the fourth electrode 331d, but the numbers of components as intermediate potential layers and intermediate electrodes may be one or may be equal to or larger than three. In a case where the numbers of components are one, one of the third potential line 363 and the fourth potential line 364 is provided but the other is not provided. In a case where the numbers of components are equal to or larger than three, an additional intermediate potential layer and an additional intermediate electrode may be provided in disposition and potentials that cause the potential at the position “285.71” to be 1.26 volt (V), the potential at the position “500.00” to be 1.5 volt (V), or the potential at the position “800.00” to be 2.14 volt (V), for example.

In the embodiment, the first region A1, the second region A2, and the third region A3 are provided as the concentric circular regions, but the liquid crystal panel 10 functions as a lens when at least the first region A1 is provided. Thus, among the concentric circular regions, any annular concentric circular region disposed outside of the first region A1 in the radial direction and surrounding the first region A1 in a plan view may be omitted. The number of such annular concentric circular regions may be one or may be equal to or larger than three.

As described above, according to the embodiment, the liquid crystal panel 10 includes two substrates (first substrate 37 and second substrate 43) and a liquid crystal (liquid crystal 40) sandwiched between the two substrates. A first substrate (first substrate 37) that is one of the two substrates includes a resistance layer (first high-resistance film 321 of the high-resistance film layer 32), an electrode layer (electrode layer 33), a first transmission part (first potential line 361), a second transmission part (second potential line 362), and an intermediate transmission part (third potential line 363, fourth potential line 364). The resistance layer is provided in a light-transmitting region (light-transmitting region AA) and has a circular outer periphery. The electrode layer is stacked with the resistance layer and has an electric resistance lower than that of the resistance layer. The first transmission part is supplied with one of two potentials different from each other. The second transmission part is supplied with the other of the two potentials different from each other. The intermediate transmission part is supplied with an intermediate potential between the two potentials different from each other. The electrode layer includes a first electrode (first electrode 331a), a second electrode (second electrode 331b), and an intermediate electrode (third electrode 331c, fourth electrode 331d). The first electrode is disposed at the center (center CE) of the resistance layer. The second electrode has an annular shape and extends along the outer periphery of the resistance layer. The intermediate electrode has an annular shape, is disposed between the first and second electrodes, and is concentric with the second electrode.

The first transmission part and the first electrode are coupled to each other, the second transmission part and the second electrode are coupled to each other, and the intermediate transmission part and the intermediate electrode are coupled to each other.

Accordingly, the potential gradient from the inner side toward the outer side of the resistance layer (first high-resistance film 321 of the high-resistance film layer 32) in the radial direction can be highly accurately matched to the potential gradient (for example, the potential gradient Lre illustrated in FIG. 8) corresponding to the order of the potential of the first transmission part (first potential line 361) provided to the first electrode (first electrode 331a), the potential of the intermediate transmission part (third potential line 363, fourth potential line 364) provided to the intermediate electrode (third electrode 331c, fourth electrode 331d), and the potential of the second transmission part (second potential line 362) provided to the second electrode (second electrode 331b). Thus, as compared to the configuration of the reference example in which only the first and second electrodes are provided, it is easier to approximate the potential gradient to a potential gradient more highly accurately corresponding to liquid crystal (liquid crystal 40) alignment corresponding to the curvature of a desired lens. Accordingly, the liquid crystal panel 10 can be provided as a liquid crystal panel that facilitates achieving liquid crystal alignment control that allows for more highly accurately reproducing the refractive index of light corresponding to the curvature of a lens.

Two intermediate transmission parts (third potential line 363, fourth potential line 364) and two intermediate electrodes (third electrode 331c, fourth electrode 331d) are provided. One (third electrode 331c) of the two intermediate electrodes has a smaller ring diameter than the other (fourth electrode 331d). Potentials provided to the two intermediate transmission parts are different from each other. The relation in potential magnitude between a potential provided to the first electrode (first electrode 331a) and a potential provided to the second electrode (second electrode 331b) is the same as the relation in potential magnitude between potentials provided to one of the two intermediate electrodes and the other. Thus, as compared to a configuration with one intermediate transmission part and one intermediate electrode, it is easier to more finely define the potential gradient from the inner side toward the outer side of the resistance layer (first high-resistance film 321 of the high-resistance film layer 32) in the radial direction. Accordingly, the refractive index of light corresponding to the curvature of a lens can be more highly accurately reproduced.

The first substrate (first substrate 37) includes an annular resistance layer (second high-resistance film 322, third high-resistance film 323) that is disposed in the same layer as and concentric with the resistance layer (first high-resistance film 321 of the high-resistance film layer 32) and surrounds the resistance layer. The electrode layer (electrode layer 33) includes a first annular electrode (first electrode 332a, first electrode 333a) and a second annular electrode (second electrode 332b, second electrode 333b). The first annular electrode extends along the inner periphery of the annular resistance layer, and the second annular electrode extends along the outer periphery of the annular resistance layer. The first transmission part (first potential line 361) and the first annular electrode are coupled to each other. The second transmission part (second potential line 362) and the second annular electrode are coupled to each other. Thus, an optical effect similar to that of what is called a Fresnel lens can be achieved with the liquid crystal panel 10. Accordingly, an optical effect similar to that of a Fresnel lens can be achieved with a planar panel such as the liquid crystal panel 10.

The first transmission part (first potential line 361), the second transmission part (second potential line 362), and the intermediate transmission part (third potential line 363, fourth potential line 364) are each coupled to the electrode layer through a contact (for example, contact 351v, 351w, 352v, 352w, 353v, 353w, 351j, 351k illustrated in FIG. 4) provided integrally with the electrode layer (electrode layer 33). Accordingly, components for coupling can be formed together with the electrode layer (electrode layer 33) when forming the electrode layer.

A second substrate (second substrate 43) that is the other of the two substrates (first substrate 37 and second substrate 43) includes a common electrode layer (common electrode 42) provided to cover the light-transmitting region (light-transmitting region AA) and facing the electrode layer (electrode layer 33) with the liquid crystal (liquid crystal 40) interposed therebetween. The liquid crystal is controlled, in accordance with a potential gradient generated in the resistance layer by combination of the two potentials different from each other and the intermediate potential, so that the refractive index of the light-transmitting region for light entering the light-transmitting region in a facing direction of the two substrates differs between the first electrode and the second electrode. The first high-resistance film 321 is an example of the resistance layer, the potentials of the first potential line 361 and the second potential line 362 are an example of the two potentials different from each other. The potential of the third potential line 363 or the fourth potential line 364 is an example of the intermediate potential. The first electrode 331a is an example of the first electrode, and the second electrode 331b is an example of the second electrode. Accordingly, the liquid crystal panel 10 can achieve an optical function similar to that of a lens.

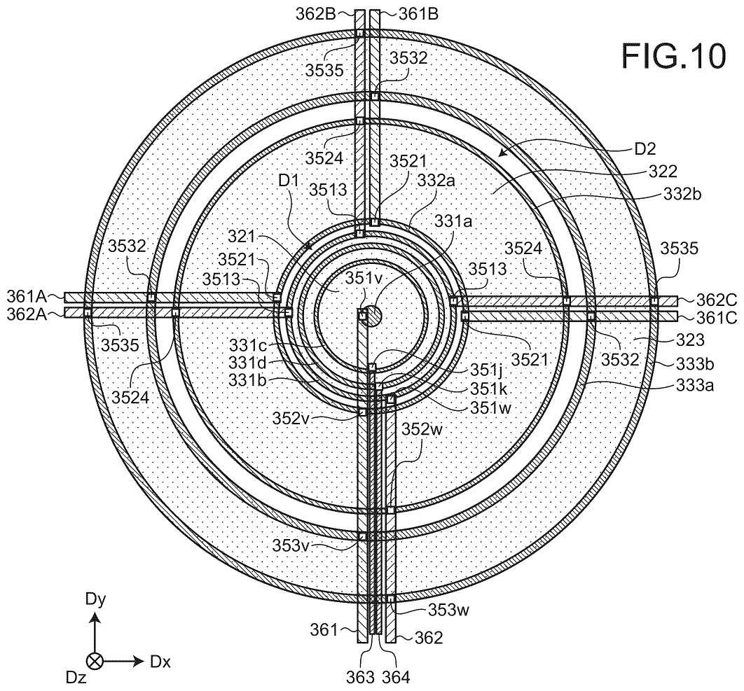

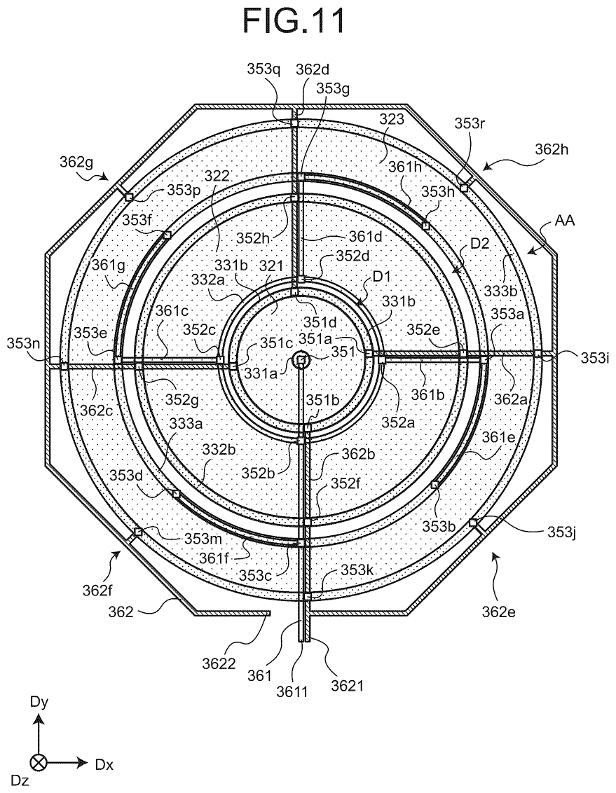

The following describes modifications of the embodiment with reference to FIGS. 10 and 11. In description of the modifications, the same components as in the embodiment are denoted by the same reference signs and description thereof is omitted.

### First Modification

FIG. 10 is a plan view illustrating a schematic structure in the light-transmitting region AA of an optical device according to a first modification. The optical device according to the first modification includes first potential lines 361A, 361B, and 361C and second potential lines 362A, 362B, and 362C in addition to the components included in the liquid crystal panel 10 of the embodiment described above with reference to FIGS. 1 to 9.

The first potential lines 361A and 361C face each other with the first high-resistance film 321 interposed therebetween. The first potential lines 361 and 361B face each other with the first high-resistance film 321 interposed therebetween. The second potential lines 362A and 362C face each other with the first high-resistance film 321 interposed therebetween. The second potential lines 362 and 362B face each other with the first high-resistance film 321 interposed therebetween.

The second electrode 331b of the first modification is provided with three contacts 3513 in addition to the contact 351w of the embodiment. The three contacts 3513 are disposed such that the circle of the second electrode 331b is divided into approximately four equal parts by the contact 351w and the three contacts 3513.

The position of one end of each of the first potential lines 361A, 361B, and 361C in a plan view overlaps the corresponding contact 3513. The other end of each of the first potential lines 361A, 361B, and 361C extends outside the second electrode 333b in the radial direction.

The first electrode 332a of the first modification is provided with three contacts 3521 in addition to the contact 352v of the embodiment. The three contacts 3521 are disposed such that the circle of the first electrode 332a is divided into approximately four equal parts by the contact 352v and the three contacts 3521. One of the three contacts 3521 overlaps the first potential line 361A in a plan view and is coupled to the first potential line 361A. Another one of the three contacts 3521 overlaps the first potential line 361B in a plan view and is coupled to the first potential line 361B. The remaining one of the three contacts 3521 overlaps the first potential line 361C in a plan view and is coupled to the first potential line 361C.

The second electrode 332b of the first modification is provided with three contacts 3524 in addition to the contact 352w of the embodiment. The three contacts 3524 are disposed such that the circle of the second electrode 332b is divided into approximately four equal parts by the contact 351w and the three contacts 3524. One of the three contacts 3524 overlaps the second potential line 362A in a plan view and is coupled to the second potential line 362A. Another one of the three contacts 3524 overlaps the second potential line 362B in a plan view and is coupled to the second potential line 362B. The remaining one of the three contacts 3524 overlaps the second potential line 362C in a plan view and is coupled to the second potential line 362C.

The first electrode 333a of the first modification is provided with three contacts 3532 in addition to the contact 353v of the embodiment. The three contacts 3532 are disposed such that the circle of the first electrode 333a is divided into approximately four equal parts by the contact 353v and the three contacts 3532. One of the three contacts 3532 overlaps the first potential line 361A in a plan view and is coupled to the first potential line 361A. Another one of the three contacts 3532 overlaps the first potential line 361B in a plan view and is coupled to the first potential line 361B. The remaining one of the three contacts 3532 overlaps the first potential line 361C in a plan view and is coupled to the first potential line 361C.

The second electrode 333b of the first modification is provided with three contacts 3535 in addition to the contact 353w of the embodiment. The three contacts 3535 are disposed such that the circle of the second electrode 333b is divided into approximately four equal parts by the contact 353w and the three contacts 3535. One of the three contacts 3535 overlaps the second potential line 362A in a plan view and is coupled to the second potential line 362A. Another one of the three contacts 3535 overlaps the second potential line 362B in a plan view and is coupled to the second potential line 362B. The remaining one of the three contacts 3535 overlaps the second potential line 362C in a plan view and is coupled to the second potential line 362C.

The contacts 3513, 3521, 3524, 3532, and 3535 are contacts like the contacts 35 (refer to FIG. 3). In the first modification as described above, four contacts are disposed to divide each component disposed outside the second electrode 331b, among the components included in the second electrode 331b and the electrode layer 33, into four parts.

The other end of each of the first potential lines 361A, 361B, and 361C is coupled to the same power supply point as the first potential line 361. In other words, the first potential lines 361A, 361B, and 361C are controlled to have the same potential as that of the first potential line 361. The other end of each of the second potential lines 362A, 362B, and 362C is coupled to the same power supply point as the second potential line 362. In other words, the second potential lines 362A, 362B, and 362C are controlled to have the same potential as that of the second potential line 362.

Thus, in the first modification, components included in the electrode layer 33 and provided along the outer peripheries of the concentric circular regions, are coupled to four of the second potential lines 362, 362A, 362B, and 362C through four contacts and receive four-point power supply from the four potential lines. The components included in the electrode layer 33 and provided along the outer peripheries of the concentric circular regions are, for example, the second electrodes 331b, 332b, and 333b. In the first modification, components included in the electrode layer 33 and provided along the inner peripheries of the concentric circular regions except for an innermost electrode in the first region A1, are coupled to four of the first potential lines 361, 361A, 361B, and 361C through four contacts and receive four-point power supply from the four potential lines. The first region A1 is the innermost region among the concentric circular regions. The innermost electrode is, for example, the first electrode 331a. The components included in the electrode layer 33 and provided along the inner peripheries of the concentric circular regions are, for example, the first electrodes 332a and 333a.

The first modification is the same as the embodiment except for matters otherwise stated above.

### Second Modification

The following specifically describes the first potential line 361 and the second potential line 362 among components of a second modification with reference to FIG. 11.

FIG. 11 is a plan view illustrating a schematic structure in the light-transmitting region AA of the optical device according to the first modification. Contacts 351, 351a, 351b, 351c, 351d, 352a, 352b, 352c, 352d, 352e, 352f, 352g, 352h, 353a, 353b, 353c, 353d, 353e, 353f, 353g, 353h, 353l, 353j, 353k, 353m, 353n, 353p, 353q, 353r illustrated in FIG. 11 are contacts like the contacts 35 described above with reference to FIG. 3.

The first potential line 361 of the second modification includes a base part extending from the center CE of the concentric circular regions to the outside of the concentric circular regions in the radial direction. In FIG. 11, an end part of the base part on the outer side in the radial direction is illustrated as an end part 3611. In FIG. 11, the base part aligns with the second direction Dy. In the following description of the first potential line 361, components are described with the extension direction (second direction Dy) of the base part as a reference. An end part of the first potential line 361 opposite to an end part thereof outside the light-transmitting region AA is coupled to the first electrode 331a in the light-transmitting region AA through the contact 351. Thus, the first potential line 361 is coupled to the first electrode 331a through one position (contact 351).

The first potential line 361 of the second modification includes an extended part 361b, an extended part 361c, an extended part 361d, an arc extended part 361e, an arc extended part 361f, an arc extended part 361g, and an arc extended part 361h.

The first electrode 332a of the second modification is provided with contacts 352a, 352b, 352c, and 352d. The contact 352b corresponds to the contact 352v in the embodiment, overlaps the first potential line 361 in a plan view, and couples the first electrode 332a and the first potential line 361. The contacts 352a, 352b, 352c, and 352d are disposed to divide the circle of the first electrode 332a into substantially four equal parts. Specifically, the contacts 352a and 352c face each other substantially in the first direction Dx with the first electrode 331a interposed therebetween in a plan view. The contacts 352b and 352d face each other substantially in the second direction Dy with the first electrode 331a interposed therebetween in a plan view. One of the three contacts 3521 overlaps the first potential line 361A in a plan view and is coupled to the first potential line 361A. Another one of the three contacts 3521 overlaps the first potential line 361B in a plan view and is coupled to the first potential line 361B. The remaining one of the three contacts 3521 overlaps the first potential line 361C in a plan view and is coupled to the first potential line 361C. The contacts 352a, 352b, 352c, and 352d are contacts like the contacts 35 described above with reference to FIG. 3.

The extended part 361b has one end at the position of the contact 352a in a plan view and the other end extending in the first direction Dx to a position overlapping the first electrode 333a. The extended part 361c has one end at the position of the contact 352c in a plan view and the other end extending in the first direction Dx to a position overlapping the first electrode 333a. The extended part 361d has one end at the position of the contact 352d in a plan view and the other end extending in the second direction Dy to a position overlapping the first electrode 333a.

The arc extended part 361e extends, from the other end of the extended part 361b, in the clockwise direction to form an arc of approximately ⅛ of the circumference along the edge on the inner periphery side of the second electrode 333b. The arc extended part 361f extends, from a position on the first potential line 361 overlapping the first electrode 333a, in the clockwise direction to form an arc of approximately ⅛ of the circumference along the edge on the inner periphery side of the second electrode 333b. The arc extended part 361g extends from the other end of the extended part 361c in the clockwise direction to form an arc of approximately ⅛ of the circumference along the edge on the inner periphery side of the second electrode 333b. The arc extended part 361h extends from the other end of the extended part 361d in the clockwise direction to form an arc of approximately ⅛ of the circumference along the edge on the inner periphery side of the second electrode 333b.

The contact 353a couples the first potential line 361 and the first electrode 333a at a position overlapping the other end of the extended part 361b in a plan view. The contact 353b couples the first potential line 361 and the first electrode 333a at a position overlapping an extended end of the arc extended part 361e in a plan view. The contact 353c couples the first potential line 361 and the first electrode 333a at a position on the first potential line 361 overlapping the first electrode 333a. The contact 353d couples the first potential line 361 and the first electrode 333a at a position overlapping an extended end of the arc extended part 361f in a plan view. The contact 353e couples the first potential line 361 and the first electrode 333a at a position overlapping the other end of the arc extended part 361g in a plan view. The contact 353f couples the first potential line 361 and the first electrode 333a at a position overlapping an extended end of the arc extended part 361g in a plan view. The contact 353g couples the first potential line 361 and the first electrode 333a at a position overlapping the other end of the arc extended part 361h in a plan view. The contact 353h couples the first potential line 361 and the first electrode 333a at a position overlapping an extended end of the arc extended part 361h in a plan view. Thus, the first potential line 361 is coupled to the first electrode 333a through the eight positions (contacts 353a, 353b, 353c, 353d, 353e, 353f, 353g, and 353h).

The second potential line 362 of the second modification includes a base part that has an octagonal shape and surrounds the light-transmitting region AA. One side of the octagon is divided into two parts, and the first potential line 361 is interposed between the two parts. An end part 3621 is one of the two parts extending in the first direction Dx. The end part 3621 is continuous with an extended part 362b extending in the second direction Dy. The shape of the base part of the second potential line 362 in the second modification may be any shape surrounding the light-transmitting region AA and may be, for example, a circular shape or an arc shape. However, the following description is made assuming that the second potential line 362 of the second modification is octagonal.

The second potential line 362 illustrated in FIG. 11 includes extended parts 362a, 362b, 362c, 362d, 362e, 362f, 362g, and 362h.

The extended parts 362a, 362b, 362c, and 362d each extend from a corresponding one side of the octagon of the second potential line 362 to a position overlapping the second electrode 331b in a plan view. The extended parts 362a and 362c align with the first direction Dx. The extended parts 362b and 362d align with the second direction Dy. One side of the first potential line 361 from which the extended part 362a extends and one side of the first potential line 361 from which the extended part 362c extends, face each other with the light-transmitting region AA interposed therebetween. One side of the first potential line 361 from which the extended part 362b extends and one side of the first potential line 361 from which the extended part 362d extends, face each other with the light-transmitting region AA interposed therebetween. The extended part 362a is coupled to the second electrode 331b through the contact 351a at a position where the extended end of the extended part 362a overlaps the second electrode 331b. The extended part 362a is also coupled to the second electrode 332b through the contact 352e at a position overlapping the second electrode 332b. The extended part 362a is also coupled to the second electrode 333b through the contact 353i at a position overlapping the second electrode 333b.

The extended part 362b is coupled to the second electrode 331b through the contact 351b at a position where the extended end of the extended part 362b overlaps the second electrode 331b. The extended part 362b is also coupled to the second electrode 332b through the contact 352f at a position overlapping the second electrode 332b. The extended part 362b is also coupled to the second electrode 333b through the contact 353k at a position overlapping the second electrode 333b.

The extended part 362c is coupled to the second electrode 331b through the contact 351c at a position where the extended end of the extended part 362c overlaps the second electrode 331b. The extended part 362c is also coupled to the second electrode 332b through the contact 352g at a position overlapping the second electrode 332b. The extended part 362c is also coupled to the second electrode 333b through the contact 353n at a position overlapping the second electrode 333b.

The extended part 362d is coupled to the second electrode 331b through the contact 351d at a position where the extended end of extended part 362d overlaps the second electrode 331b. The extended part 362d is also coupled to the second electrode 332b through the contact 352h at a position overlapping the second electrode 332b. The extended part 362d is also coupled to the second electrode 333b through the contact 353q at a position overlapping the second electrode 333b.

The contacts 352a, 352b, 352c, and 352d are arranged on the same circumference in the stated order in the clockwise direction with the contact 352a as a starting point. The contacts 353a, 353b, 353c, 353d, 353e, 353f, 353g, and 353h are arranged on the same circumference in the stated order in the clockwise direction with the contact 353a as a starting point.

The extended parts 362e, 362f, 362g, and 362h each extend from a corresponding one side of the octagon of the second potential line 362 to a position overlapping the second electrode 333b in a plan view.

The side of the second potential line 362 from which the extended part 362a extends, the side of the second potential line 362 from which the extended part 362b extends, the side of the second potential line 362 from which the extended part 362c extends, the side of the second potential line 362 from which the extended part 362d extends, the side of the second potential line 362 from which the extended part 362e extends, the side of the second potential line 362 from which the extended part 362f extends, the side of the second potential line 362 from which the extended part 362g extends, and the side of the second potential line 362 from which the extended part 362h extends are different from one another.

The extended part 362e is coupled to the second electrode 333b through the contact 353j at a position overlapping the second electrode 333b. The extended part 362f is coupled to the second electrode 333b through the contact 353m at a position overlapping the second electrode 333b. The extended part 362g is coupled to the second electrode 333b through the contact 353p at a position overlapping the second electrode 333b. The extended part 362h is coupled to the second electrode 333b through the contact 353r at a position overlapping the second electrode 333b.

The contacts 351a, 351b, 351c, and 351d are arranged on the same circumference in the stated order in the clockwise direction with the contact 351a as a starting point. The contacts 352e, 352f, 352g, and 352h are arranged on the same circumference in the stated order in the clockwise direction with the contact 352e as a starting point. The contacts 353ᵢ, 353j, 353k, 353m, 353n, 353p, 353q, and 353r are arranged on the same circumference in the stated order in the clockwise direction with the contact 353i as a starting point.

In FIG. 11, the third potential line 363 and the fourth potential line 364 are illustrated, but in the second modification as well, the third potential line 363 and the fourth potential line 364 are disposed between the first potential line 361 and the second potential line 362 in a plan view as in the embodiment and the first modification. Specifically, the third potential line 363 and the fourth potential line 364 are arranged in the first direction Dx and extended in the second direction Dy between the base part of the first potential line 361 and the extended part 362b of the second potential line 362.

The second modification is the same as the embodiment except for matters otherwise stated above.

When a resistance ratio is defined to be the effective value of the difference in electric resistance between the inner and outer periphery sides of the circular or annular high-resistance film layer 32 in one concentric circular region, the resistance ratio is affected by not only a first resistance but also a second resistance. The first resistance is the electric resistance generated between the inner and outer periphery sides of the high-resistance film layer 32 due to the width (corresponding to a width La illustrated in FIG. 11) of the high-resistance film layer 32 in the radial direction. The second resistance is the electric resistance of the electrode layer 33 depending on the circumferential length (corresponding to a length Lb illustrated in FIG. 11) of the concentric circular region where the high-resistance film layer 32 is provided. Specifically, the resistance ratio corresponds to a value obtained by dividing the first resistance by the second resistance. The resistance ratio needs to exceed 100 and is desirably 1000 approximately. To obtain such a resistance ratio, it is often desirable for the first resistance to be larger and the second resistance to be smaller. However, the high-resistance film layer 32 disposed in the outer concentric circular region has a smaller width in the radial direction. Therefore, it is more difficult to ensure the first resistance in the outer concentric circular region. Thus, in the modifications, a plurality of contacts that transmit potentials from the first potential line 361 and the second potential line 362 are provided to divide the circumferential length of a concentric circular region into multiple sections, thereby making the second resistance smaller. As a result, the resistance ratio is ensured. If the resistance ratio significantly exceeds 1000, the voltage gradient becomes less steep, making it difficult to produce the refractive index difference described above with reference to FIG. 4, and thus it is desirable that the resistance ratio is approximately 1000.

According to the modifications described above, the second electrode (second electrode 331b), the first annular electrode (first electrode 332a, first electrode 333a), and the second annular electrode (second electrode 332b, second electrode 333b) are provided with a plurality of contacts (refer to FIGS. 10 and 11). Specifically, k contacts provided on the second electrode are arranged to divide the ring of the second electrode into k parts. In addition, m contacts provided on the first annular electrode are arranged to divide the ring of the first annular electrode into m parts. Moreover, n contacts provided on the second annular electrode are arranged to divide the ring of the second annular electrode into n parts. In the first modification, k=m=n=4. In the second modification, k=4 and m=n=8. The numbers k, m, and n are not limited to these exemplary values but may be other values (e.g., equal to or greater than two). Specifically, some of the contacts exemplarily described in the first and second modifications may be omitted or additional contacts may be provided in accordance with designing. In a case where contacts are added, transmission parts such as the first potential line 361 and the second potential line 362 extend to positions where the additional contacts are disposed, and are coupled to components included in the electrode layer 33 through contacts at positions overlapping the components.

In the modifications, among the components included in the second electrode 331b and the electrode layer 33, components disposed outside the second electrode 331b are provided with potentials from a plurality of positions. This makes it easier to stabilize the potential of any annular electrode provided outside the second electrode 331b across the entire circumferential direction.

The liquid crystal panel 10 of the embodiment is an electrically controlled birefringence (ECB) liquid crystal panel. Thus, the direction of initial alignment determined by the alignment film 41 and the direction of initial alignment determined by the alignment film 31 are parallel to each other in a plan view and have an antiparallel relation. However, specific aspects of the liquid crystal panel 10 such as characteristics of the alignment films 31 and 41 described above are merely exemplary and do not limit the form of the liquid crystal panel according to the present disclosure. The specific form of the liquid crystal panel may be changed as appropriate within the scope of the claims.

It should be understood that the present disclosure provides any other effects achieved by aspects described above in the present embodiment, such as effects that are clear from the description of the present specification or effects that could be thought of by the skilled person in the art as appropriate.

What is claimed is:

1. A liquid crystal panel comprising:
two substrates; and
a liquid crystal sandwiched between the two substrates, wherein
a first substrate that is one of the two substrates includes
a resistance layer provided in a light-transmitting region and having a circular outer periphery,
an electrode layer stacked with the resistance layer and having an electric resistance lower than that of the resistance layer,
a first transmission part configured to be provided with one of two potentials different from each other,
a second transmission part configured to be provided with the other of the two potentials different from each other, and
an intermediate transmission part configured to be provided with an intermediate potential between the two potentials different from each other,
the electrode layer includes
a first electrode disposed at a center of the resistance layer,
a second electrode that has an annular shape and extends along the outer periphery of the resistance layer, and
an intermediate electrode that has an annular shape, is disposed between the first and second electrodes, and is concentric with the second electrode,
the first transmission part and the first electrode are coupled to each other,
the second transmission part and the second electrode are coupled to each other, and
the intermediate transmission part and the intermediate electrode are coupled to each other.

2. The liquid crystal panel according to claim 1, comprising two of the intermediate transmission parts and two of the intermediate electrodes, wherein
one of the two intermediate electrodes has a smaller ring diameter than the other,
potentials provided to the two intermediate transmission parts are different from each other, and
the relation in potential magnitude between a potential provided to the first electrode and a potential provided to the second electrode is the same as the relation in potential magnitude between potentials provided to one of the two intermediate electrodes and the other.

3. The liquid crystal panel according to claim 1, wherein
the first substrate includes an annular resistance layer that is disposed in the same layer as and concentric with the resistance layer and surrounds the resistance layer,
the electrode layer includes a first annular electrode and a second annular electrode, the first annular electrode extending along the inner periphery of the annular resistance layer, the second annular electrode extending along the outer periphery of the annular resistance layer,
the first transmission part and the first annular electrode are coupled to each other, and
the second transmission part and the second annular electrode are coupled to each other.

4. The liquid crystal panel according to claim 3, wherein the first transmission part, the second transmission part, and the intermediate transmission part are each coupled to the electrode layer through a contact provided integrally with the electrode layer.

5. The liquid crystal panel according to claim 4, wherein the second electrode, the first annular electrode, and the second annular electrode are each provided with a plurality of the contacts.

6. The liquid crystal panel according to claim 5, wherein
k contacts provided on the second electrode are arranged to divide the ring of the second electrode into k parts,
m contacts provided on the first annular electrode are arranged to divide the ring of the first annular electrode into m parts, and
n contacts provided on the second annular electrode are arranged to divide the ring of the second annular electrode into n parts, and
k, m, and n are natural numbers equal to or greater than two.

7. The liquid crystal panel according to claim 1, wherein
a second substrate that is the other of the two substrates includes a common electrode layer provided to cover the light-transmitting region and facing the electrode layer with the liquid crystal interposed therebetween, and
the liquid crystal is controlled, in accordance with a potential gradient generated in the resistance layer by combination of the two potentials different from each other and the intermediate potential, so that the refractive index of the light-transmitting region for light entering the light-transmitting region in a facing direction of the two substrates differs between the first and second electrodes.

8. The liquid crystal panel according to claim 2, wherein
a second substrate that is the other of the two substrates includes a common electrode layer provided to cover the light-transmitting region and facing the electrode layer with the liquid crystal interposed therebetween, and
the liquid crystal is controlled, in accordance with a potential gradient generated in the resistance layer by combination of the two potentials different from each other and the intermediate potential, so that the refractive index of the light-transmitting region for light entering the light-transmitting region in a facing direction of the two substrates differs between the first and second electrodes.
